(19) United States
(12) Patent Application Publication
(10) Pub. No.: US 2026/0054233 A1
(43) Pub. Date: Feb. 26, 2026

(54) TANK DESIGN FOR CEMENT AND CEMENT-CONTAMINATED WASTES PRIOR TO SUBTERRANEAN INJECTION

(71) Applicant: Advantek Waste Management Services, LLC, Houston, TX (US)

(72) Inventor: Jared Ives, Houston, TX (US)

(21) Appl. No.: 19/228,832

(22) Filed: Jun. 5, 2025

Related U.S. Application Data
(60) Provisional application No. 63/657,094, filed on Jun. 6, 2024.

(51) Int. Cl. B01F 23/50; B01F 23/53; B01F 23/70; B01F 27/113; B01F 27/191; B01F 27/85; B01F 27/91; B01F 101/28; B09B 1/00; B09B 3/38; B09B 101/45; E21B 33/13

(52) U.S. Cl. CPC B01F 23/59; B01F 23/511; B01F 23/53; B01F 23/565; B01F 23/713; B01F 27/113; B01F 27/191; B01F 27/85; B01F 27/91; B09B 1/008; B09B 3/38; E21B 33/13; B01F 2101/28; B01F 2215/0431; B01F 2215/044; B09B 2101/45

(57) ABSTRACT

A storage and processing tank having a jet line with injection nozzles, agitators, and a fluid supply line, is used to maintain cement waste in an injectable form prior to injecting the materials into a subterranean formation for disposal.

### CROSS-REFERENCE TO RELATED APPLICATIONS

This is an International Application for Patent under the auspices of the PCT and claims priority to U.S. Provisional application No. 63/657,094, filed Jun. 6, 2024.

### FIELD

The disclosure generally relates to methods and apparatus for the storage and processing of cement and cement-contaminated fluids prior to injecting the materials into a subterranean formation for disposal.

### BACKGROUND

Disposal of waste fluids by injection or fracturing injection into a zone in a subterranean formation is known in the art. The waste slurry is injected into a target zone during a waste injection or disposal operation. Slurry waste is often injected repeatedly into the formations, such as in batches.

Injection of cement or cement-contaminated waste fluid presents difficulties in storage and processing prior to injection. Disclosed herein are embodiments of a tank and mixer design for use with cement and cement-contaminated wastes. The tank and mixer can be used with cement retardants, which are known in the art.

### BRIEF DESCRIPTION OF THE DRAWINGS

Drawings of the preferred embodiments of the present disclosure are attached hereto so that the embodiments of the present disclosure may be better and more fully understood:

FIG. 1 is a schematic of an exemplary embodiment of the disclosure wherein a cement waste tank is provided with agitators, a jet line with nozzles, and an input with a screen according to aspects of the disclosure.

### DETAILED DESCRIPTION OF CERTAIN EMBODIMENTS

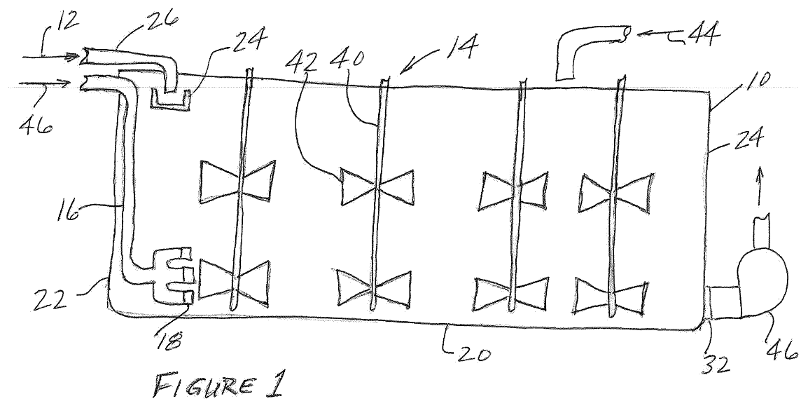

The disclosed methods and apparatus generally relate to methods for the storage and processing of cement and cement-contaminated fluids prior to injecting the materials into a subterranean formation for disposal. FIG. 1 is a schematic of an exemplary embodiment of the disclosure wherein a cement waste tank is provided with agitators, a jet line with nozzles, and an input with a screen according to aspects of the disclosure and is discussed throughout.

As used herein “cement waste” includes cement and/or cement-contaminated fluids and slurries. For example, cement contaminated waste is often created during cementing or casing of an oil or gas well. Excess cement may be created to insure the job does not run short on cement. Cement pumped downhole to case the well can be flowed back to the surface as part of clean-up after the cement job. Wash water used to clean-up cement equipment typically carries cement particles as well. Often this cement waste is dried, broken up, and disposed of in landfills. If the cement contaminated waste is liquid or semi-liquid, it is often easier to inject the waste material into a subterranean formation. However, cement waste can be thick, viscous, and difficult to handle, flow through pipes and fluid control devices (e.g., pumps and the like), and prone to unwanted hardening. The disclosure provides a storage and processing tank used to maintain cement waste in an injectable form prior to injecting the materials into a subterranean formation for disposal.

A tank 10 is provided for storage and treatment of the cement waste 12. Inside the tank 10 are a plurality of agitators 14. A fluid input line 16 with a plurality of nozzles 18 provides fluid 46 to the tank. The fluid can be water, a water-based fluid, saltwater, brine, etc., as is known in the art. The fluid can be other liquids as are known in the art. The nozzles 18 are positioned at or near the bottom 20 of the tank 10, and at or near the input side 22 of the tank 10, to keep fluid moving towards the discharge end 24 of the tank. A cement waste input tubular 26 is provided for connection to a waste truck or other waste source. A screen 28 is positioned at the input end 30 of the waste input tubular 26 to remove aggregate and other solids from the cement waste 12. An outlet 32 is provided at the discharge end 24 of the tank 10. A recirculation system can be employed to recirculate the cement waste (and added fluid). For example, a recirculation pump 46 can receive the waste cement from the tank outlet 32 and recirculate the waste cement back into the tank. When ready, the cement waste is removed from the tank through the outlet 32 and injected into the subterranean zone.

The agitators 14 can be top-entry agitators, as shown, having a drive shaft 40 and one or more impeller 42. The impellers can be helical, paddles or turbine impellers. The agitators can be side-entry agitators, jet agitators, or pump-based agitators. A plurality of agitators can be utilized.

In an exemplary embodiment, a 500 barrel capacity round bottom tank is provided with a candy cane waste input tubular for providing the cement waste from a waste truck or waste source. Four 15-hp agitators, each with dual 36-inch, canted impellers are positioned in the tank for agitating the cement waste. A jet line with three 1-¾ inch nozzles is positioned on the front end of the tank. A 75-hp 6×5×14 centrifugal pump with turbine-curved blade impeller is used to recirculate the tank trough. The jet line is aimed at the floor to keep fluid moving towards the discharge at the other end of the tank. A four-inch candy cane is used to offload cement waste from trucks. The candy cane ends at a one-foot square box with, for example, ½ inch spread steel acting as a filter to catch the aggregate inside of the cement waste before it enters the tank. Obviously, these specifics are exemplary only. Persons of skill in the art will recognize variations and other arrangements.

The system can be used with cement retarders 44. Cement retarders are known in the art. Cement retarders include lignosulfonates, borates, phosphates and phosphonates, for example. An exemplary retarder is sugar drinking soda, more specifically Mountain Dew (tradename) soda. It is possible to use or create a sugar slurry as an additive or retardant for the cement waste using the soda.

In an embodiment, a sugar slurry is created, namely, a liquid sugar slurry with phosphoric acid to bring the pH of the cement waste to about 1.5. The sugar slurry keeps the cement waste from setting up and hardening. One five-gallon batch is added per every 100 barrels of cement waste or cement. In an embodiment, twenty-four liters of Mountain Dew (tradename) can be used as a retardant per 100 barrels of cement waste or cement.

### Conclusion

The words or terms used herein have their plain, ordinary meaning in the field of this disclosure, except to the extent explicitly and clearly defined in this disclosure or unless the specific context otherwise requires a different meaning. If there is any conflict in the usages of a word or term in this disclosure and one or more patent(s) or other documents that may be incorporated by reference, the definitions that are consistent with this specification should be adopted.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

While the foregoing written description of the disclosure enables one of ordinary skill to make and use the embodiments discussed, those of ordinary skill will understand and appreciate the existence of variations, combinations, and equivalents of the specific embodiments, methods, and examples herein. The disclosure should therefore not be limited by the above-described embodiments, methods, and examples. While this disclosure has been described with reference to illustrative embodiments, this description is not intended to be construed in a limiting sense. Various modifications and combinations of the illustrative embodiments as well as other embodiments of the disclosure will be apparent to persons skilled in the art upon reference to the description. It is, therefore, intended that the appended claims encompass any such modifications or embodiments.

The particular embodiments disclosed above are illustrative only, as the present disclosure may be modified and practiced in different but equivalent manners apparent to those skilled in the art having the benefit of the teachings herein. It is, therefore, evident that the particular illustrative embodiments disclosed above may be altered or modified and all such variations are considered within the scope of the present disclosure. The various elements or steps according to the disclosed elements or steps can be combined advantageously or practiced together in various combinations or sub-combinations of elements or sequences of steps to increase the efficiency and benefits that can be obtained from the disclosure. It will be appreciated that one or more of the above embodiments may be combined with one or more of the other embodiments, unless explicitly stated otherwise. Furthermore, no limitations are intended to the details of construction, composition, design, or steps herein shown, other than as described in the claims.

The systems, methods, and apparatus in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be but are to provide at least one explanation of how to make and use the present disclosure. The limits of the embodiments of the present disclosure and the bounds of the patent protection are measured by and defined in the following claims.

It is claimed:

1. A method of storing and processing cement waste prior to injection of the cement waste into a subterranean formation, comprising:
input cement waste into a tank;
input a fluid into the tank through a plurality of nozzles, each of the plurality of nozzles positioned at or near a bottom of the tank and directed towards a discharge side of the tank;
agitate the cement waste and fluid in the tank using a plurality of agitators positioned in the tank, each of the plurality of agitators having a plurality of impellers;
output the cement waste and fluid from the tank for injection into the subterranean formation.

2. The method of claim 1, further comprising screening the cement waste prior to inputting the cement waste into the tank.

3. The method of claim 1, wherein the fluid is water or a water-based liquid.

4. The method of claim 1, wherein each of the plurality of agitators are about fifteen horsepower agitators, each with dual, about thirty-six inch, canted impellers.

5. The method of claim 1, further comprising supplying the fluid to the plurality of nozzles through a fluid jet line.

6. The method of claim 1, further comprising adding a retardant to the cement waste.

7. The method of claim 6, wherein the retardant is a sugar drinking soda.

8. The method of claim 7, further comprising adding the retardant in a ratio of about five gallons per every 100 barrels of cement waste.

9. The method of claim 1, further comprising adding a sugar drinking soda as a retardant to the cement waste in a ratio of about twenty-four liters per every 100 barrels of cement waste.

10. A storing and processing apparatus for cement waste prior to injection of the cement waste into a subterranean formation, comprising:
a tank for holding a cement waste;
a jet line for inputting a fluid into the tank, the jet line fluidly connected to a plurality of nozzles, each of the plurality of nozzles positioned at or near a bottom of the tank and directed towards a discharge side of the tank;
a plurality of agitators positioned in the tank, each of the plurality of agitators having a plurality of impellers, the agitators for agitating the cement waste and the fluid;
a supply of sugar drinking soda for adding to the cement waste in the tank as a retardant; and
an output in the tank for flowing the cement waste and fluid from the tank for injection into the subterranean formation.

11. The method of claim 1, further comprising a screen for screening the cement waste prior to inputting the cement waste into the tank.

12. The method of claim 1, wherein the fluid is water or a water-based liquid.

13. The method of claim 1, wherein each of the plurality of agitators are about fifteen horsepower agitators, each with dual, about thirty-six inch, canted impellers.

14. The method of claim 10, wherein the retardant is supplied to the cement waste in the tank in a ratio of about five gallons per every 100 barrels of cement waste.

15. The method of claim 10, wherein the retardant is supplied to the cement waste in the tank in a ratio of about twenty-four liters per every 100 barrels of cement waste.
